(19) United States
(12) Patent Application Publication
(10) Pub. No.: US 2026/0103921 A1
(43) Pub. Date: Apr. 16, 2026

(54) OUTSIDE HANDLE DEVICE

(71) Applicant: TOYOTA JIDOSHA KABUSHIKI KAISHA, Toyota-shi (JP)

(72) Inventors: Tetsuya NAGASAKI, Okazaki-shi (JP); Yuta Ito, Toyota-shi (JP); Kazuki Takenaka, Nagoya-shi (JP)

(73) Assignee: TOYOTA JIDOSHA KABUSHIKI KAISHA, Toyota-shi (JP)

(21) Appl. No.: 19/285,177

(22) Filed: Jul. 30, 2025

(30) Foreign Application Priority Data
Oct. 16, 2024 (JP) 2024-180639

(51) Int. Cl. E05B 85/10; E05B 85/06

(52) U.S. Cl. CPC E05B 85/103; E05B 85/06

(57) ABSTRACT

A door outer panel has an elongated hole. The longitudinal direction of the elongated hole coincides with the vehicle front-rear direction. A first door handle is disposed near the elongated hole on the inner surface side of the door outer panel. A second door handle and a mechanical key cylinder are disposed inside the elongated hole. A cover covers the mechanical key cylinder. The mechanical key cylinder is disposed in a rear end portion of the elongated hole. An exposed surface of the cover is disposed in an inclined manner such that a front end of the exposed surface is positioned inward of a rear end of the exposed surface in a vehicle width direction.

### CROSS-REFERENCE TO RELATED APPLICATION

This application claims priority to Japanese Patent Application No. 2024-180639 filed on Oct. 16, 2024. The disclosure of the above-identified application, including the specification, drawings, and claims, is incorporated by reference herein in its entirety.

### BACKGROUND

### 1. Technical Field

The present specification discloses outside handle devices for vehicles.

### 2. Description of Related Art

A vehicle door is provided with an outside handle. Japanese Unexamined Patent Application Publication No. 2023-103912 (JP 2023-103912 A) discloses a flush handle device. The flush handle device includes a door handle. When the door handle is in a retracted state, the exposed surface (outer surface) of the door handle is flush with a door outer panel.

A retractable outside handle is also known as another type of handle device. An opening is formed in a door outer panel. A door handle is provided inside the opening. For example, the door handle is a part of an electric opening and closing mechanism. When a sensor detects the operation of the door handle, a motor is activated and winds up a wire. A door latch is thus released by the wire.

### SUMMARY

To install a retractable door handle, an opening is formed in a door outer panel. When a vehicle is traveling, air may flow into the opening, which can deteriorate the aerodynamic characteristics of the vehicle.

Therefore, an outside handle device is provided in the present disclosure. This device can reduce deterioration of the aerodynamic characteristics of a vehicle when a retractable door handle is provided in a vehicle door.

The present disclosure discloses an outside handle device.
The outside handle device includes a door outer panel, a first door handle, a second door handle, a mechanical key cylinder, and a cover.
The door outer panel has an elongated hole. The longitudinal direction of the elongated hole coincides with a vehicle front-rear direction.
The first door handle is disposed near the elongated hole on the inner surface side of the door outer panel. The first door handle is a part of an electric opening and closing mechanism.
The second door handle is disposed inside the elongated hole. The second door handle is a part of a mechanical opening and closing mechanism.
The mechanical key cylinder is configured to unlock and lock a vehicle door. The mechanical key cylinder is disposed inside the elongated hole.
The cover covers the mechanical key cylinder.
The mechanical key cylinder is disposed in a rear end portion of the elongated hole.
An exposed surface of the cover is disposed in an inclined manner such that a front end of the exposed surface is positioned inward of a rear end of the exposed surface in a vehicle width direction.

The airflow along the door outer panel changes its flow direction so as to flow obliquely from the front edge of the elongated hole into the opening of the elongated hole. With the above configuration, the exposed surface of the cover disposed in the rear end portion of the elongated hole receives the airflow and guides it to the outside of the vehicle.

In the above configuration,
the second door handle may be disposed forward of the mechanical key cylinder.
In this case, an exposed surface of the second door handle is disposed in an inclined manner. That is, a front end of the exposed surface of the second door handle is positioned inward of a rear end of the exposed surface of the second door handle in the vehicle width direction. The rear end of the exposed surface of the second door handle is connected to the front end of the exposed surface of the cover.

With the above configuration, an inclined surface is formed that continuously extends from the front end of the exposed surface of the second door handle to the rear end of the exposed surface of the cover.

In the above configuration,
the cover may have an insertion hole. The insertion hole is provided to allow the cover to be removed.

The insertion hole is provided between a rear end of the cover and a rear end of the elongated hole.

For example, the user inserts a mechanical key into the insertion hole to pry open the cover. Damage to the second door handle during prying can be avoided by providing the insertion hole at a position away from the second door handle.

The outside handle device disclosed in the present specification can reduce deterioration of the aerodynamic characteristics of a vehicle when a retractable door handle is provided in a vehicle door.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a side view of a vehicle illustrating an outside handle device according to the present embodiment;

FIG. 2 is a cross-section taken along line II-II in FIG. 1;

FIG. 3 is a cross-section taken along line III-III in FIG. 2;

FIG. 4 is an enlarged view of FIG. 3 illustrating the operation of the second door handle; and

FIG. 5 is an enlarged view of FIG. 3 and is a view for explaining the flow of air during vehicle travel.

### DETAILED DESCRIPTION OF EMBODIMENTS

Hereinafter, an outside handle device according to the present embodiment will be described with reference to the drawings. The shapes, materials, numbers, and numerical values described below are illustrative examples. These shapes and the like can be appropriately changed according to the specifications of the outside handle device. In the following, like elements are given the same reference signs in all drawings.

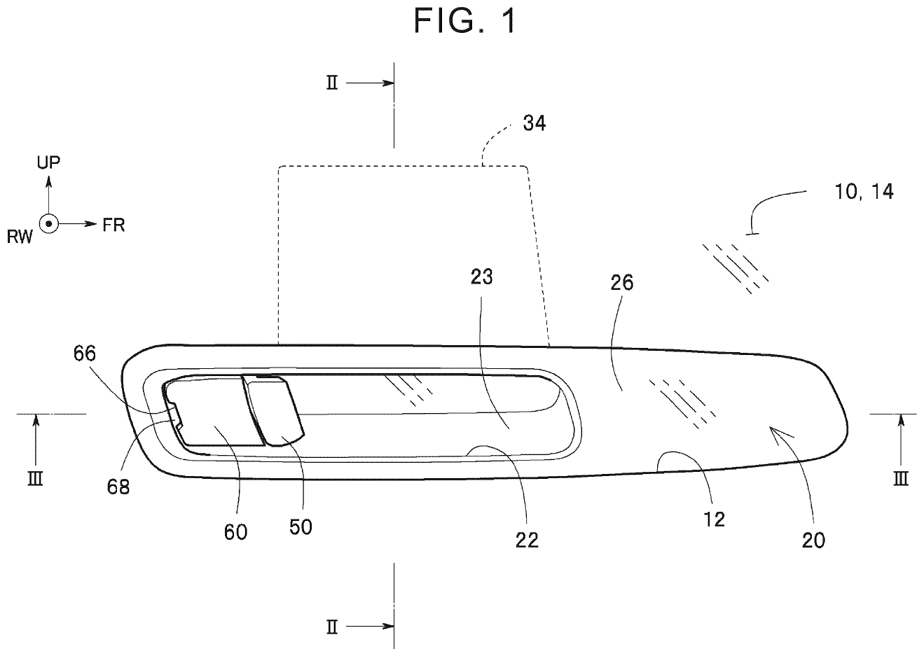

In addition, in FIGS. 1 to 5, a Cartesian coordinate system including a FR axis, a RW axis, and a UP axis is used to represent positions and orientations of respective components. The FR axis is an axis in a vehicle front-rear direction. The RW axis is an axis in a vehicle width direction. The UP axis is an axis in a vehicle up-down direction. The positive direction of the FR axis is a direction toward the front of the vehicle. The positive direction of the RW axis is a direction toward the right of the vehicle. The positive direction of the UP axis is an upper direction.

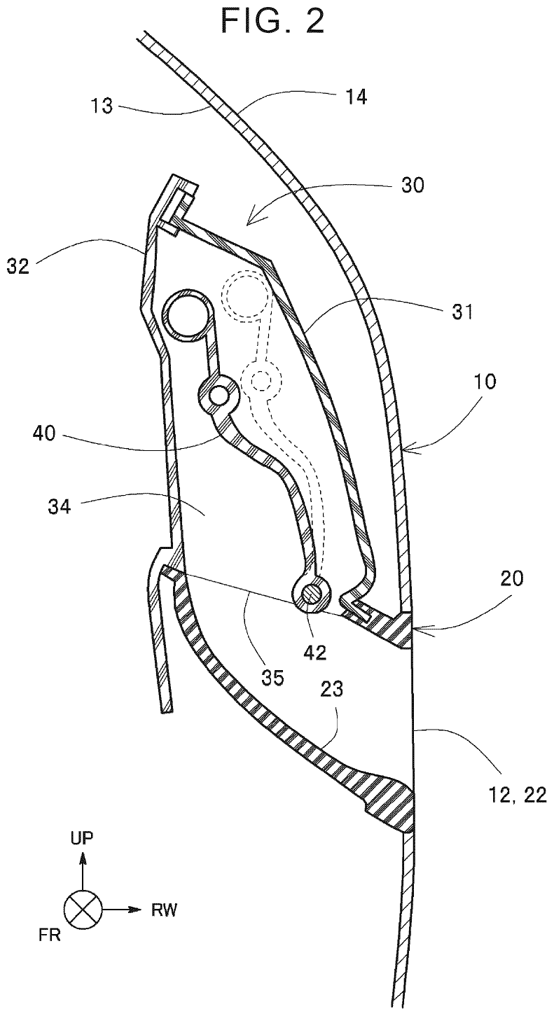

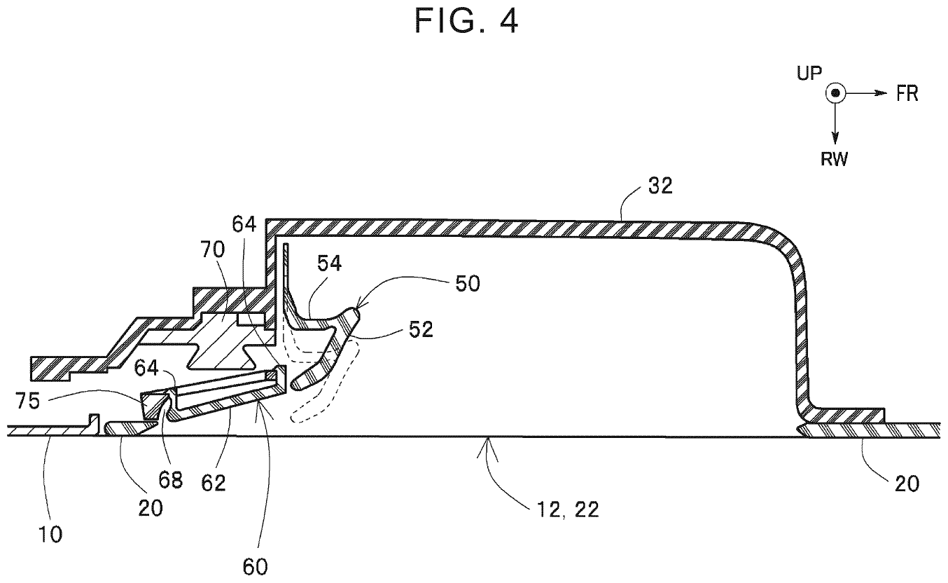

The outside handle device according to the present embodiment is provided in a driver's seat door of a vehicle. In FIGS. 1 to 5, an outside handle device in a so-called right handle vehicle is exemplified. The outside handle device according to the present embodiment includes a door outer panel 10, a first door handle 40 (see FIG. 2), a second door handle 50 (see FIG. 4), a mechanical key cylinder 70, and a cover 60.

### 1. Side of Vehicle

FIG. 1 illustrates a side view of a vehicle. More particularly, an enlarged view of the right vehicle door is illustrated in FIG. 1. As a panel material on the exposed surface (outer surface) side of the vehicle door, a door outer panel 10 is provided on the vehicle door.

FIG. 2 illustrates II-II cross-section of FIG. 1. The door outer panel 10 is made of a metallic material or a resinous material such as CFRP. The door outer panel 10 includes an exposed surface 14 and an inner surface 13. The exposed surface 14 is exposed to the outside. The inner surface 13 is opposite to the exposed surface 14. The inner surface 13 faces a door inner panel (not shown).

With the door outer panel 10 and the door inner panel (not shown), the vehicle door is provided with space. In this space, an electric opening and closing mechanism illustrated in FIG. 2 is arranged.

Referring to FIG. 1, an elongated hole 12 is drilled in the door outer panel 10. The elongated hole 12 has a longitudinal direction in the vehicle front-rear direction. A garnish 20 is fitted into the elongated hole 12. The garnish 20 includes an exposed surface 26 and an opening 22. The exposed surface 26 is disposed on the same surface as the exposed surface 14 of the door outer panel 10. An opening 22 is formed in the exposed surface 26 toward the rear in the vehicle front-rear direction. An electric opening and closing mechanism and a mechanical opening and closing mechanism are disposed inside the opening 22. Detailed structures of the electric opening and closing mechanism and the mechanical opening and closing mechanism will be described later.

The garnish 20 includes a guide surface 23 that connects with the opening 22. A guide surface 23 is connected to a lower edge of the opening 22. Referring to FIG. 2, the guide surface 23 is an upwardly inclined structure that moves upward toward the inner side in the vehicle width direction.

When a hand is inserted into the opening 22, the fingertip is guided upward along the guide surface 23. That is, the fingertip is guided into the operation space 34 according to the guide surface 23. When a finger touches the first door handle 40 in the operation space 34, the first door handle 40 is operated.

### 2. Electric Opening and Closing Mechanism

Referring to FIGS. 1 and 2, the vehicle door is provided with an electric opening and closing mechanism. The electric opening and closing mechanism includes a housing 30 and a first door handle 40.

The housing 30 has an opening 35 formed at a lower end thereof. The opening 35 of the housing 30 is connected to the opening 22 of the garnish 20. The housing 30 extends upward from the opening 35. For example, the housing 30 has an inverted U-shaped cross-section in II-II cross-section (FIG. 2). For example, the housing 30 includes a housing outer 31 and a housing inner 32.

The internal space of the housing 30 serves as an operation space 34. A first door handle 40 is disposed in the operation space 34. That is, the first door handle 40 is disposed on the inner surface 13 side of the door outer panel 10 and in the vicinity of the elongated hole 12. In other words, the first door handle 40 is stored in the opening 22.

The first door handle 40 is rotatable with the shaft 42 as a rotation axis. The shaft 42 extends in the vehicle front-rear direction. Therefore, the first door handle 40 swings along the vehicle width direction to a basic position indicated by a solid line and an abutting position indicated by a broken line. In the abutting position, the first door handle 40 abuts against the housing outer 31.

When the first door handle 40 is moved from the basic position to the abutting position, the vehicle door is opened by an electric unlocking operation. Since this unlocking operation is known, the operation will be briefly described below.

The movement of the first door handle 40 is sensed by a sensor (not shown). The sensing signal is sent to a verification ECU (not shown). The verification ECU searches for a vehicle key in the vicinity of the vehicle. When the identification information of the searched vehicle-key matches the information registered in advance, the verification ECU transmits an unlocking command to a body ECU (not shown).

The body ECU unlocks the vehicular doors. For example, the body ECU switches an actuator (not shown) for latching (not shown) from a disconnected state to an energized state. Further, the body ECU drives the actuator to release the latching of the vehicular door from the striker (not shown). As a result, the vehicle door is opened.

As described above, in the electric opening and closing mechanism, the operation of unlocking and opening the vehicle door is performed only by the operation of the first door handle 40.

### 3. Mechanical Opening and Closing Mechanism

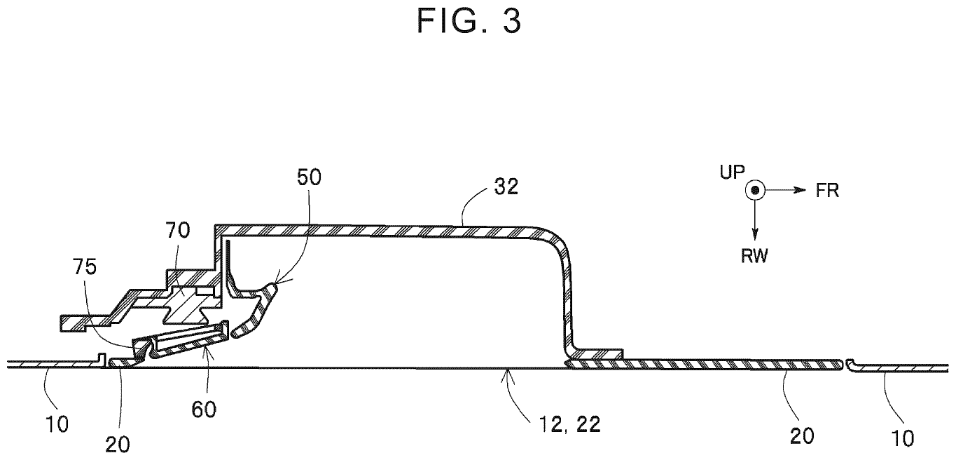

Referring to FIGS. 1 and 3, the outside handle device according to the present embodiment includes a mechanical opening and closing mechanism. The mechanical opening and closing mechanism is a so-called emergency-compatible opening and closing mechanism. For example, a mechanical opening and closing mechanism does not require power supply.

Referring to FIGS. 1 and 3, the mechanical opening and closing mechanism includes a second door handle 50, a mechanical key cylinder 70, and a cover 60. The second door handle 50, the mechanical key cylinder 70, and the cover 60 are disposed inside the elongated hole 12 of the door outer panel 10. More specifically, the second door handle 50, the mechanical key cylinder 70, and the cover 60 are disposed inside the opening 22.

A mechanical key cylinder 70 is disposed in a rear end portion of the elongated hole 12 and the opening 22 along the vehicle front-rear direction. The cover 60 covers the mechanical key cylinder 70. Accordingly, the cover 60 is also disposed in the rear end portion of the elongated hole 12.

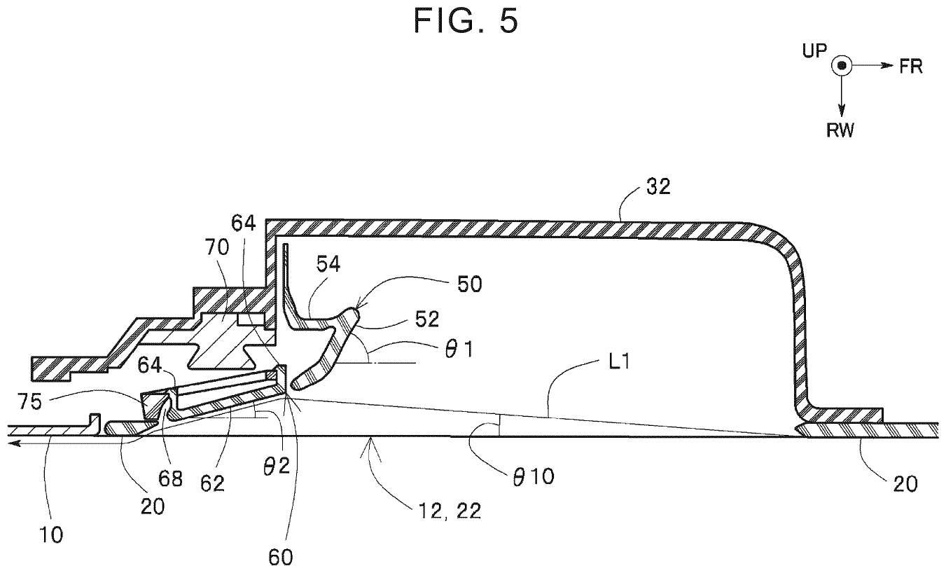

A second door handle 50 is disposed adjacent to the front of the mechanical key cylinder 70. As will be described later, an inclined surface is formed by the exposed surface 52 (see FIG. 5) of the second door handle 50 and the exposed surface 62 of the cover 60. The inclined surface functions as a guide surface for guiding the air flowing into the opening 22 to the outside of the vehicle.

In FIGS. 4 and 5, an enlarged view of FIG. 3 is illustrated. The second door handle 50 includes an exposed surface 52 and an operation surface 54. The exposed surface 52 is exposed to the outside of the vehicle. The exposed surface 52 is disposed in an inclined manner such that its front end is positioned inward of its rear end in the vehicle width direction.

For example, the inclination angle θ1 (see FIG. 5) of the front end portion of the exposed surface 52 is larger than the inclination angle θ2 of the exposed surface 62 of the cover 60 (θ1>θ2). That is, the front end of the exposed surface 52 extends deep into the opening 22. As will be described later, the air entering the opening 22 is scooped by the exposed surfaces 52, 62 and discharged to the outside of the vehicle.

An operation surface 54 is connected to a front end of the exposed surface 52. The operation surface 54 faces the housing inner 32. That is, when the vehicle door is viewed from the side, the operation surface 54 is a hidden surface. An operator's finger comes into contact with the operation surface 54.

The second door handle 50 is movable along the vehicle width direction. In FIG. 4, the basic position of the second door handle 50 is indicated by a solid line. Also, the open position of the second door handle 50 is shown in dashed lines. The rear end of the exposed surface 52 in the basic position is connected to the front end of the cover 60. That is, the exposed surface 52 of the second door handle 50 and the exposed surface 62 of the cover 60 form a continuous inclined surface.

Mechanical key cylinder 70 performs unlocking and locking of the vehicle door. A mechanical key (not shown) of the user is inserted into the mechanical key cylinder 70. When the mechanical key cylinder is rotated with the mechanical key inserted, the vehicle door is switched from the locked state to the unlocked state.

For example, in the unlocked state, the second door handle 50 and a wire (not shown) are connected. The wire is connected to a latch (not shown) of the vehicle door. That is, when the second door handle 50 is pulled from the basic position to the open position, the latch is pulled by the wire to rotate. This opens the vehicle door.

The mechanical key cylinder 70 is seated on the housing inner 32. The second door handle 50 and the mechanical key cylinder 70 are adjacent to each other in the vehicle front-rear direction. Further, the mechanical key cylinder 70 is covered with a cover 60.

The cover 60 is disposed outward of the mechanical key cylinder 70 in the vehicle width direction. The cover 60 includes an exposed surface 62 and a claw 64. The claw 64 extends in the vehicle width direction. The claw 64 is provided at the front and rear ends of the cover 60.

The claw 64 engages the frame 75. For example, the frame 75 is arranged coaxially with the mechanical key cylinder 70. For example, a mechanical key cylinder 70 is disposed within the frame of the frame 75.

Referring to FIG. 1, an insertion hole 68 is formed between the rear end of the cover 60 and the rear end of the elongated hole 12. In order to remove the cover 60, an insertion hole 68 is formed. For example, a notch 66 is formed in the rear end of the cover 60. The notch 66 forms an insertion hole 68 between the rear end of the cover 60 and the rear end of the opening 22.

Referring to FIGS. 1 and 4, a tool such as a mechanical key (not shown) or a driver is inserted into the insertion hole 68. Then, the cover 60 is opened by the inserted mechanical key or the like. Since the insertion hole 68 is formed at a position away from the second door handle 50, damage to the second door handle 50 during the prying operation is suppressed.

The cover 60 includes an exposed surface 62. The exposed surface 62 is disposed in an inclined manner such that its front end is positioned inward of its rear end in the vehicle width direction. The front end of the exposed surface 62 is connected to the rear end of the exposed surface 62 of the second door handle 50. Further, the rear end of the exposed surface 62 is connected to the garnish 20.

### 4. Aerodynamic Characteristics of Mechanical Opening and Closing Mechanism

Referring to FIG. 5, an inclined surface is formed by the exposed surface 52 of the second door handle 50 and the exposed surface 62 of the cover 60. The inclined surface enters the vehicle width direction inner side toward the vehicle front side.

By forming an inclined surface in the rear end portion of the opening 22, the air entering the opening 22 is discharged to the outside of the vehicle. For example, when the vehicle is traveling at high speed (e.g., at or above the speed-per-hour 80 km), such an airflow as that shown by L1 enters the opening 22. The airflow L1 is guided by the exposed surface 62 of the cover 60 and discharged to the outside of the vehicle.

Even when the inflow angle of the outside air exceeds the angle θ10 due to an external environment or the like, the exposed surface 52 of the second door handle 50 scoops the inflow air. The scooped air is sent to the exposed surface 62 of the cover 60 and discharged to the outside of the vehicle.

As described above, according to the outside handle device of the present embodiment, the air that has flowed into the opening 22 while the vehicle is traveling is discharged to the outside of the vehicle by the inclined surfaces of the second door handle 50 and the cover 60. Therefore, the stagnation of the air in the opening 22 is suppressed.

What is claimed is:

1. An outside handle device comprising:
a door outer panel having an elongated hole, a longitudinal direction of the elongated hole coinciding with a vehicle front-rear direction;
a first door handle of an electric opening and closing mechanism, the first door handle being disposed near the elongated hole on an inner surface side of the door outer panel;
a second door handle of a mechanical opening and closing mechanism, the second door handle being disposed inside the elongated hole;
a mechanical key cylinder disposed inside the elongated hole, the mechanical key cylinder being configured to unlock and lock a vehicle door; and
a cover that covers the mechanical key cylinder, wherein:
the mechanical key cylinder is disposed in a rear end portion of the elongated hole; and
an exposed surface of the cover is disposed in an inclined manner such that a front end of the exposed surface is positioned inward of a rear end of the exposed surface in a vehicle width direction.

2. The outside handle device according to claim 1, wherein:
the second door handle is disposed forward of the mechanical key cylinder;
an exposed surface of the second door handle is disposed in an inclined manner such that a front end of the exposed surface is positioned inward of a rear end of the exposed surface in the vehicle width direction; and
the rear end of the exposed surface of the second door handle is connected to the front end of the exposed surface of the cover.

3. The outside handle device according to claim 1, wherein:
the cover has an insertion hole configured to allow the cover to be removed; and
the insertion hole is provided between a rear end of the cover and a rear end of the elongated hole.
